(19) United States
(12) Patent Application Publication
(10) Pub. No.: US 2002/0169815 A1
(43) Pub. Date: Nov. 14, 2002

(54) Method and apparatus for configuration independent simulation of network layer conditions

(76) Inventors: Francis Wong, Boston, MA (US); Eduard Rozman, Waltham, MA (US); George R. Plouffe, Haverhill, MA (US)

Correspondence Address: KUDIRKA & JOBSE, LLP, ONE STATE STREET, SUITE 1510, BOSTON, MA, 02109, US

(21) Appl. No.: 09/852,482

(22) Filed: May 10, 2001

(51) Int. Cl. G06F 9/00; G06F 13/10; G06F 13/12; G06F 9/44

(52) U.S. Cl. 709/100; 703/21

(57) ABSTRACT

A network layer verification mechanism (NLVM) is inserted between DUTs or between a DUT and the test bench components in order to simulate conditions that can occur in a packetized network connection, such as dropped packets, duplicate packets, corrupted packets out-of-order packets and delayed packets. The NLVM has internal storage and an application programmer interface (API) which can be driven by the test bench and comprises a plurality of methods that allow packets received by the NLVM to be selectively forwarded through the object, temporarily stored in the object or the packet data to be corrupted. The NLVM is implemented as an object with an interface that is independent of the simulation configuration so that verification test benches and tests can be written with no reliance on bus functional models and environment-specific details.

### FIELD OF THE INVENTION

This invention relates to verification and testing of hardware design simulations, and, in particular, to the construction of automated test benches for verifying hardware designs simulated with convention HDL languages.

### BACKGROUND OF THE INVENTION

Modern electronic circuits are increasingly being fabricated with Application Specific Integrated Circuits (ASICs), which are chips that contain custom designed circuits. Increasing chip complexity and size, combined with the rapidly changing technologies and very short time-to-market windows requires that circuitry be designed and tested rapidly. Typically, circuits are designed using computer simulations that model the circuits and permit them to be tested before the circuit is actually committed to fabrication.

Computer simulations are performed using a Hardware Description Language (HDL) to conceptually model the circuit. The HDL is a text format for describing the inputs, outputs and behavior of electronic circuits and systems. When the HDL text is compiled by a simulation tool, the result is a computer circuit model that performs according to the HDL description. The computer circuit model can be used for verification of the circuit operation through simulation, for timing analysis, for test analysis (testability analysis and fault grading) and for logic synthesis.

There are several standard HDLs presently in wide use that can be used to simulate electronic circuits. Two of the most popular are Verilog and VHDL. The Verilog HDL is defined by IEEE standard No. 1364 that includes a document known as a language reference manual. This document provides a complete and authoritative definition of the Verilog HDL. IEEE Standard 1364 also defines a programming language interface that is a collection of software routines that permit a bi-directional interface between Verilog and other languages. In the description that follows, the Verilog HDL will be used as an example. However, it would be understood by those skilled in the art that other conventional HDL languages could be used without departing from the spirit and scope of the invention.

The Verilog HDL can be used to model the circuit being tested, typically called the “design under test” or DUT from a set of design specifications. The model can be specified at a module level with low-level binary operators in a continuous assignment or at a higher conceptual level called a register transfer level (RTL.) When the design is described at using RTL statements, the Verilog code describes how data is transformed by pure combinatorial logic as it passes between conceptual registers.

Verilog can also be used to generate a testing circuit, called a “test bench” that can generate stimulus patterns which, in turn, can be used to test the DUT. Generally, the DUT simulation and the test bench for that DUT are designed together from the same specifications so that the test bench generates a stimulus pattern specifically for the particular DUT, called a “test scenario”, that mimics all possible real world signal combinations and verifies that the operation of the DUT is correct under all conditions. The test bench also receives outputs generated by the DUT and displays or stores the outputs for later analysis by the circuit designers.

Often different teams of designers are used for the DUT and the test bench so that the test bench designers have the opportunity to generate test scenarios without a bias introduced by the design effort in designing the DUT. However, the design of a test bench can be just as difficult and time consuming as the design of the DUT. Because HDL was created to model a DUT and not a test bench, it lacks some features that make it efficient for designing test benches. Consequently, designers had been forced to resort to a complicated mixture of HDLs and other languages, such as C, C++ and Perl to create verification code. Consequently, the verification process that was once a minor part of the development cycle was becoming a major part of the design effort.

Consequently, conventional tools have been developed in order to simplify the test bench design task and reduce the time necessary to completely design a test bench. These tools generally use a specialized hardware verification language (HVL) that has been specifically designed to quickly model test benches. Some verification tools have additional features, such as the ability to automatically monitor results generated by the DUT and the ability to generate additional tests based on the information gathered from the DUT operation.

Although these automated test bench tools often provide significant advantages in the test and verification of simulated circuits, there are still problems remaining. For example, while the tools provide adequate features and functionality for testing DUTs in isolation, in situations where several DUTs that are connected together, for example by a network, must be tested, the conventional test bench tools cannot adequately control the signals passing between DUTs.

In addition, test benches developed with the tools are still tightly coupled to the precise simulation for which they were designed, thereby limiting the reusability of the test bench code.

Therefore, there is a need to enhance existing verification system tools in order to provide the capability of simulating and controlling network layer connections and for providing increased test bench code reusability.

### SUMMARY OF THE INVENTION

In accordance with the principles of the present invention, a network layer verification mechanism (NLVM) is inserted between DUTs or between a DUT and the test bench components. The NLVM has internal storage and can be controlled to simulate conditions that can occur in a packetized network connection, such as dropped packets, duplicate packets, corrupted packets and out-of-order packets. The NLVM also has an application programmer interface (API) that can be driven by the test bench and that is independent of the simulation configuration. In this manner, code reuse is promoted.

In one embodiment, the NLVM is implemented as a specialized object written in an HVL. The object includes internal storage in the form of an associative array and a plurality of methods that allow packets received by the object to be selectively forwarded through the object, temporarily stored in the object or the packet data to be corrupted.

In another embodiment, the methods in the specialized object form an interface that is independent of the simulation configuration so that verification test benches and tests can be written with no reliance on bus functional models and environment-specific details.

### BRIEF DESCRIPTION OF THE DRAWINGS

The above and further advantages of the invention may be better understood by referring to the following description in conjunction with the accompanying drawings in which:

FIG. 1 is a block schematic diagram of a conventional test bench connected to a design under test.

FIG. 2 is a block schematic diagram of a conventional test bench connected to two interconnected designs under test.

FIG. 3 is a block schematic diagram of a test bench connected to two interconnected designs under test and utilizing two NLVMs in accordance with the principles of the invention.

FIG. 4 is a block schematic diagram of a test bench connected to a single design under test that also utilizes an NLVM in accordance with the principles of the invention.

FIG. 5 is a schematic diagram of the details of an NLVM.

FIG. 6 is a flowchart illustrating the steps in a process performed by an NLVM in creating a dropped packet condition.

FIGS. 7A and 7B, when placed together, form a flowchart illustrating the steps in a process performed by an NLVM in creating an out-of-order packet condition.

FIGS. 8A and 8B, when placed together, form a flowchart illustrating the steps in a process performed by an NLVM in creating a duplicate packet condition.

FIGS. 9A and 9B, when placed together, form a flowchart illustrating the steps in a process performed by an NLVM in creating a corrupted packet condition.

### DETAILED DESCRIPTION

As previously mentioned, in order to ensure that a simulated hardware design is functionally correct, tests are written to verify that the simulated hardware design behaves as specified. To accomplish this, the tests apply a stimulus to the DUT simulation, and subsequently check the response of the DUT.

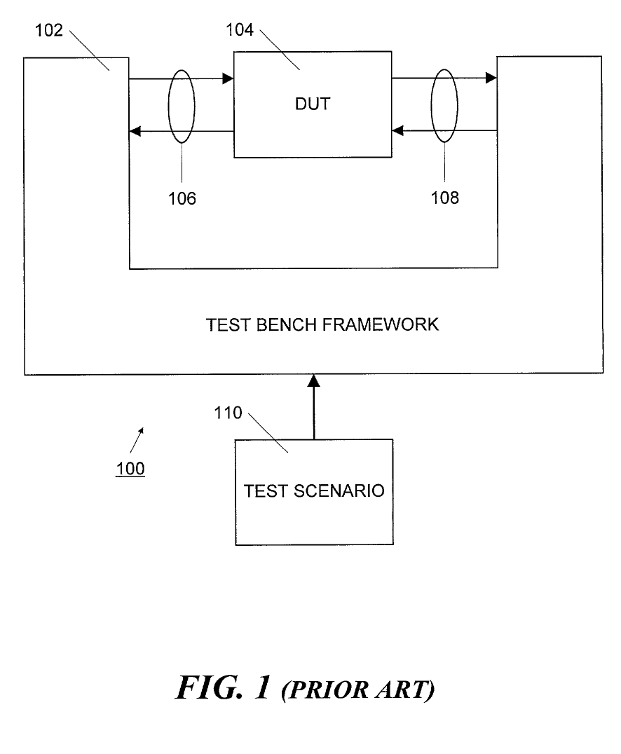

A conventional ASIC verification environment 100 may be similar to that shown in FIG. 1. It consists of a test bench framework 102 that is being used to verify the operation of a design under test 106. In this arrangement, the DUT 106 is an RTL model of a particular hardware circuit. As an illustrative example, the circuit to be tested could be an InfiniBand^{SM} host channel adapter and the DUT 106 might be an RTL model of the hardware portion of the host channel adapter implementing the transport layer and link layer protocols of the specification. The host channel adapter construction and the transport and link layer protocols are described in detail in the InfiniBand Specification Rev 1.0, The InfiniBand^{SM} Trade Association (2000) which specification is incorporated by reference herein in its entirety. The host channel adapter is used for exemplary purposes only and those skilled in the art would realize that other circuits and designs could be tested using the principles of the invention.

In order to verify the operation of one or more DUTs 104, tests are written and executed. The tests can be thought of as abstractions that can be realized by a number of components. In the example illustrated in FIG. 1, these components include the testbench framework 102 and a test scenario 110.

The testbench framework 102 is a code base composed of common functions and routines, which facilitate the generation of stimuli 106 and the comparison of the response 108 of the DUT 104 to an expected response. As previously mentioned, the testbench framework 102 can be designed using conventional tools that are optimized for designing testbenches. These conventional tools include the VERA™ System Verifier developed and marketed by Synopsis, Inc., 700 East Middlefield Road, Mountain View, Calif. 94043. The VERA testbench automation system is based on VERA hardware verification language (HVL) that is a high-level, object-oriented programming language developed specifically to meet the unique requirements of functional verification. The VERA system can be used to develop self-checking test benches that automatically generate reactive tests. The VERA system allows verification designers to model the target environment at a high level of abstraction, essentially creating a virtual prototype. From this environment, VERA can automatically generate self-checking tests that mimic the “real-life” stimulus. During simulation, the VERA system monitors coverage points in the simulated design and uses the results to dynamically generate new tests to cover untested areas. In the discussion below, the VERA system will be used for exemplary purposes. However, those skilled in the art would realize that other conventional verification systems could also be used without departing from the spirit and scope of the invention.

The testbench framework 102 is driven by the test scenario code 110. The test scenario code 110 controls the testbench framework 102 to generate a set of stimuli 106 that test selected functional areas of the design. A complete verification process may consist of running a large number of test scenarios to provide a high coverage of the total design functionality. The test scenario 110 can also be designed on the aforementioned VERA verification system in a conventional manner.

In some cases it is necessary to generate stimuli 106 which mimic the behavior of a network in order to test the response of a design to various conditions that occur in design layers that interface with the network. For example, these conditions include dropped data packets, out-of-order data packets, duplicate data packets, corrupted data packets and delayed data packets (increased packet latency). In a standalone environment with a single ASIC, such as that illustrated in FIG. 1, these conditions may be created by the testbench 102 operating under control of an appropriate test scenario 110.

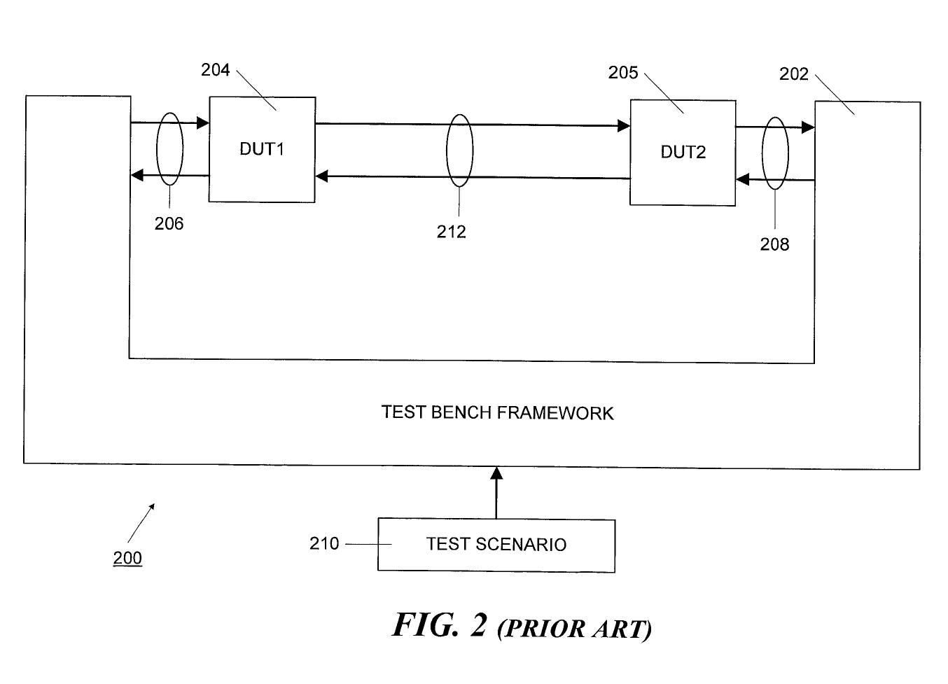

However, some simulation configurations require that two DUTs that are interconnected by a network be simultaneously tested and verified. Such an arrangement 200 is shown in FIG. 2. For example, such a simulation may be used to test the network and link layers in two InfiniBand^{SM} host channel adapters 204 and 205 which are connected by a network 212. In a multi-chip environment such as shown in FIG. 2, the testbench framework 202 operating under control of the test scenario 210, can generate stimuli 206 and receive responses 208 from the DUTs 204 and 205, but it would not be possible to create conditions that occur at the InfiniBand^{SM} network and link layers, such as dropped packets, out-of-order packets, duplicate packets, corrupted packets and delayed packets with the testbench framework 202.

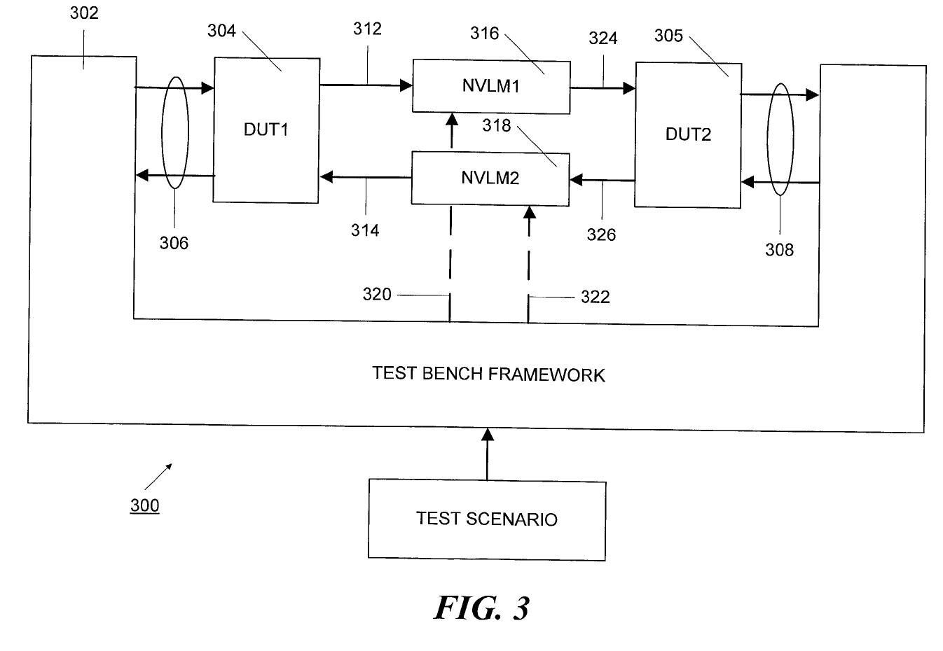

In accordance with the principles of the invention and as shown in FIG. 3, the simulation configuration shown in FIG. 2 is modified to include two network layer verification mechanisms (NLVMs) 316 and 318. Components in FIG. 3 that correspond to those in FIG. 2 have been given corresponding numeral designations. For example, DUT 304 in FIG. 3 corresponds to DUT 204 in FIG. 2. As with the configuration illustrated in FIG. 2, the testbench framework 302 operating under control of the test scenario 310 can generate stimuli 306 and receive responses 308 from the DUTs 304 and 305. The NLVMs 316 and 318 provide the ability for the testbench framework 302 and the test scenario 310 to create the conditions that occur in the network, for example, at the InfiniBand^{SM} network and link layer layers, including dropped packets, out-of-order packets, duplicate packets, and corrupted packets.

In particular, NLVM 316 is inserted in one network direction and NLVM 318 is inserted in the return direction. NLVM 316 receives data packets from DUT 304 as schematically indicated by arrow 312 and selectively transmits data packets to DUT as schematically indicated by arrow 324. Similarly, NLVM 318 receives data packets from DUT 305 as schematically indicated by arrow 326 and selectively transmits data packets to DUT 304 as schematically indicated by arrow 314. As discussed in detail below, NLVM 316 operates under commands generated by testbench framework 302 that are indicated schematically by arrow 320 and NLVM 318 operates under commands generated by testbench framework 302 that are indicated schematically by arrow 322. In a preferred embodiment, these commands are API calls.

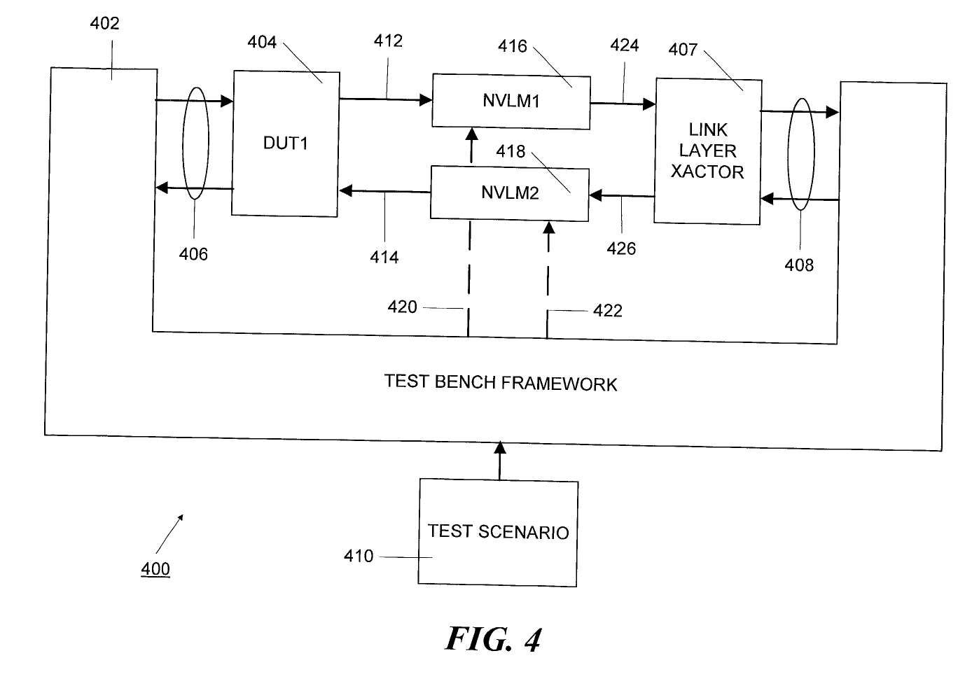

Some advantages can also be gained by using an NLVM in a standalone ASIC environment. The standalone environment with the single InfiniBand^{SM} host channel adapter ASIC is shown in FIG. 4 wherein components that correspond to those in FIGS. 2 and 3 have been given corresponding numeral designations. Rather than having two host channel adapters 304, 305 as illustrated in FIG. 3, one host channel adapter 305 has been replaced by a verification component 407. The new component 407 is called an InfiniBand^{SM} link layer transactor 407. The code that simulates the transactor 407 receives data packet structures as described by the test scenario 410 and drives the proper data symbols as stimulus to the DUT 404. By using the transactor component 407, the test scenarios 410 can target the finer grain functionalities of the InfiniBand^{SM} Link layer protocol. As depicted in this diagram, NLVM 416 is inserted in one network direction and NLVM 418 is inserted in the return direction. NLVM 416 receives data packets from DUT 404 as schematically indicated by arrow 412 and selectively transmits data packets to transactor 407 as schematically indicated by arrow 424. Similarly, NLVM 418 receives data packets from transactor 407 as schematically indicated by arrow 426 and selectively transmits data packets to DUT 404 as schematically indicated by arrow 414. As discussed in detail below, NLVM 416 operates under commands generated by testbench framework 402 that are indicated schematically by arrow 420 and NLVM 418 operates under commands generated by testbench framework 402 that are indicated schematically by arrow 422. In a preferred embodiment, these commands are also API calls.

As shown in FIG. 4, NLVMs 416 and 418 can be used in the single ASIC environment to create the InfiniBand^{SM} network layer conditions, requiring little or no change in the testbench framework 402 or test scenarios 410 from the multi ASIC environment shown in FIG. 3 for creating these conditions. Thus, the testbench code can be reused.

Each NLVM is an object that is instantiated from a VERA™ HVL class. The following is a simplified class definition of an exemplary NLVM:

class NetworkLayerVerificationMechanism {

local lbPacket ib₁₃packet_array[ ];

event packet₁₃ingress_event;

// enable/disable auto packet forwarding

task enable_auto packet_forwarding( );

task disable_auto_packet_forwarding( );

// storing, immediate forward, and transmit stored packets

function integer store_ingress_packet( );

task transmit_ingress_packet( );

task transmit_stored_packet(integer packet_handle);

// retrieving packets at the ingress and stored packets

function IbPacket get_ingress_packet( );

function IbPacket get_stored_packet(integer packet_handle);

function integer remove_stored_packet(integer packet_handle);

function integer modify_stored_packet(integer packet_handle, lbPacket packet);

// returning header information about current packet at ingress

function integer get_ingress packet_vl( );

function integer get_ingress_packet_dest_qp( );

}

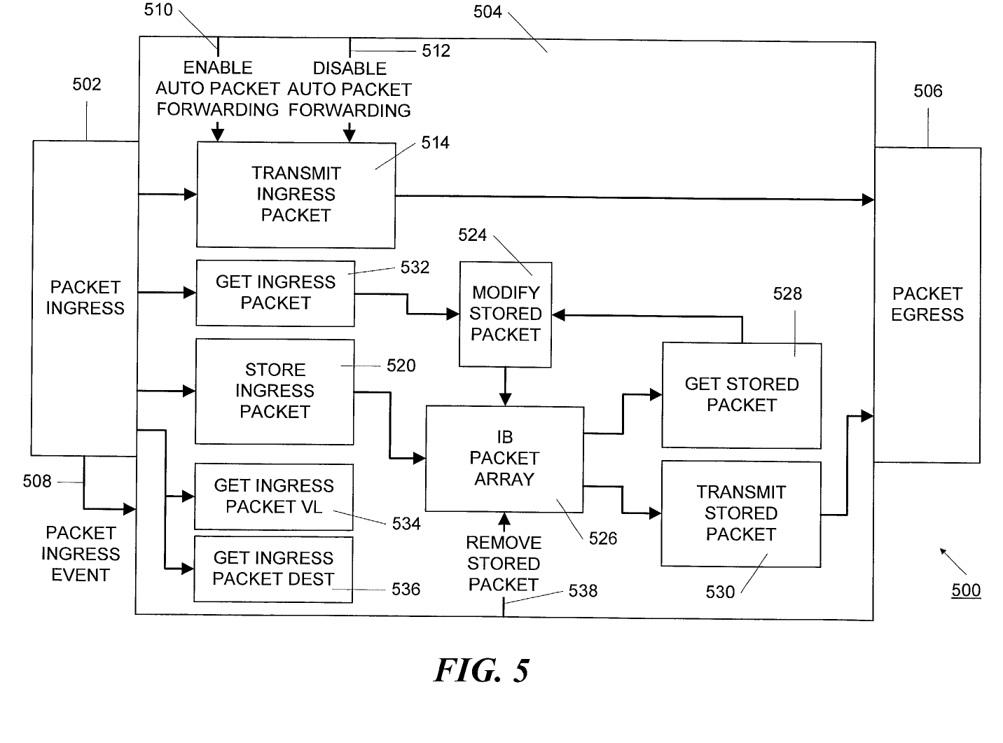

FIG. 5 shows a schematic view of an NVLM object 500. This particular object has been designed to create the aforementioned InfiniBand^{SM} network and link layer condition, but those skilled in the art would recognize that other network layer conditions could easily be simulated with a similar object. The object has a packet ingress section 502, a processing section 504 and a packet egress section 506. A preferred embodiment of the invention uses a VERA™ associative array as an IB packet array 526 to store a data packet for later transmission. When a packet arrives at the ingress section 502, the store_ingress_packet( ) function 520 can store the packet in the array 526 for later transmission or retransmission. An event 528 indicates when there is a packet in the ingress section 502. This event 528 is triggered by the NLVM when the complete packet has gone through the ingress section. Accordingly, this operation creates a start up time cost, as a packet will not egress from the NLVM until the complete packet has arrived at the ingress section 502. However, after the first packet has arrived, packets can be pipelined so that, as packets arrive at the ingress section, other packets are forwarded to the egress section 506 simultaneously. However, if there are packet size differences, then there will be added latency. In addition, latency will be introduced as packets are stored and later retransmitted, if the packets should be immediately forwarded to the egress section 506.

Automatic packet forwarding can also be enabled as indicated schematically by arrow 510, which cause the transmit_ingress_packet( ) function 514 to immediately forward packets to the egress section 506 as the packets arrive at the ingress section 502. To enable automatic packet forwarding, the enable_auto_packet_forwarding( ) task would be invoked. Invoking the disable_auto_packet_forwarding( ) task 512 would disable the function.

Two functions 534 and 536 are provided to obtain information about a packet that has arrived at the ingress section 502, which may be used, for example, to make a decision to forward or store the packet. The get_ingress_packet_vl( ) is used to obtain the virtual lane number and the get_ingress_packet_dest_qp( ) function obtains the destination queue pair number. If a packet that has arrived at the ingress section 502 is to be immediately forwarded, and assuming that automatic packet forwarding is disabled, then the transmit_ingress_packet( ) function 514 must be invoked. If the transmit_ingress_packet( ) function 514 is not invoked a dropped packet condition is created.

Alternatively, if the packet is to be stored, the store_ingress_packet( ) function 520 is invoked. This latter function returns a “packet handle”, which is a unique identifier used to retrieve the packet at a later time. The packet is stored in the associative array 526. Both the store_ingress_packet( ) function 520 and the transmit_ingress_packet( ), function can be invoked on the same ingress packet. This double invocation has the effect of storing the packet as well as immediately forwarding the packet. This operation may be used to create duplicate packets.

A stored packet may be transmitted by invoking the transmit_stored_packet(packet_handle) function 528. When this function is invoked, the packet handle must be supplied through the task parameter list. The store_ingress_packet( ) function 520 and the transmit_stored_packet(packet_handle) function 528 can be used together to introduce a varying amount of latency in transmission of packets through the NLVM object 500. In particular, the store_ingress_packet( ) function 520 can be used to stored incoming packets that can be transmitted after waiting the desired latency time with the transmit_stored_packet( packet_handle) function 528. Bursts of packets can also be sent this way as well.

There are additional functions to retrieve packets located in the ingress section 502 or packets that have been stored in the associative array 526. The function get_ingress_packet( ) 532 returns the packet at the ingress section 502. The get_stored_packet(packet_handle) function 530 returns a stored packet; the packet handle to the packet in the associative array must be supplied when calling this function.

The remove_stored_packet(packet_handle) function 538 removes a previously stored packet from the associative array 526. A packet handle must also be supplied to this function when it is invoked.

Finally, to corrupt a packet, the packet must first be obtained by invoking the get_ingress_packet( ) function 532. The packet contents can then be modified.

Finally, the modified packet is stored by invoking the modify_stored_packet(packet_handle, packet) function 524. The second function parameter (packet) is the newly modified packet. The stored packet can then transmitted with the transmit_stored_packet(packet_handle) function 528.

The following flowcharts and code example demonstrate how to create the four aforementioned InfiniBand^{SM} network layer conditions. In accordance with InfiniBand^{SM} protocol, data packets travel on “virtual lanes” established through a switch fabric. For a detailed discussion of InfiniBand^{SM} switch fabric and virtual lanes, see the InfiniBand^{SM} specification referred to above. In the following flowcharts and example, packets on virtual lane (VL) 1 are used to demonstrate the creation of a dropped packet condition. Packets on VL 2 are used to demonstrate the creation of an out-of-order packet condition. Packets on VL 3 demonstrate the creation of a duplicate packet condition, and packets on VL 4 are used to demonstrate corrupted packet conditions.

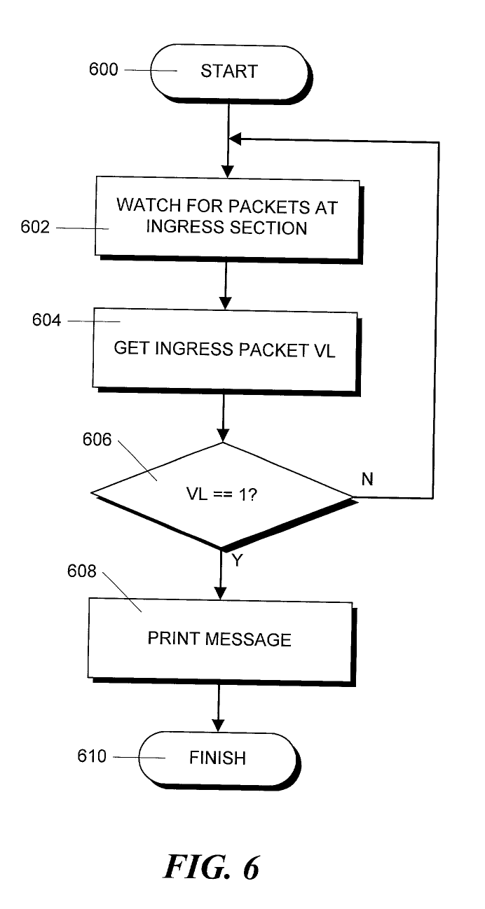

FIG. 6 is a flowchart that illustrates use of the NLVM API to create a network layer condition in which packets are dropped. This procedure starts in step 600 and proceeds to step 602 where the process watches for packets at the ingress section 502 of the NLVM by monitoring the packet-ingress-event mechanism. When a packet has been detected, the process proceeds to step 604 where the ingress packet virtual lane is obtained by invoking the get_ingress_packet_vl( ) function.

Next, in step 606, a determination is made whether the virtual lane is equal to one. If not, the process returns to step 602 to watch for additional packets. Alternatively, if, in step 606, it is determined that the packet has arrived on virtual lane 1, then the packet is dropped by printing a message in step 608 rather than transmitting the packet. The process then terminates in step 610.

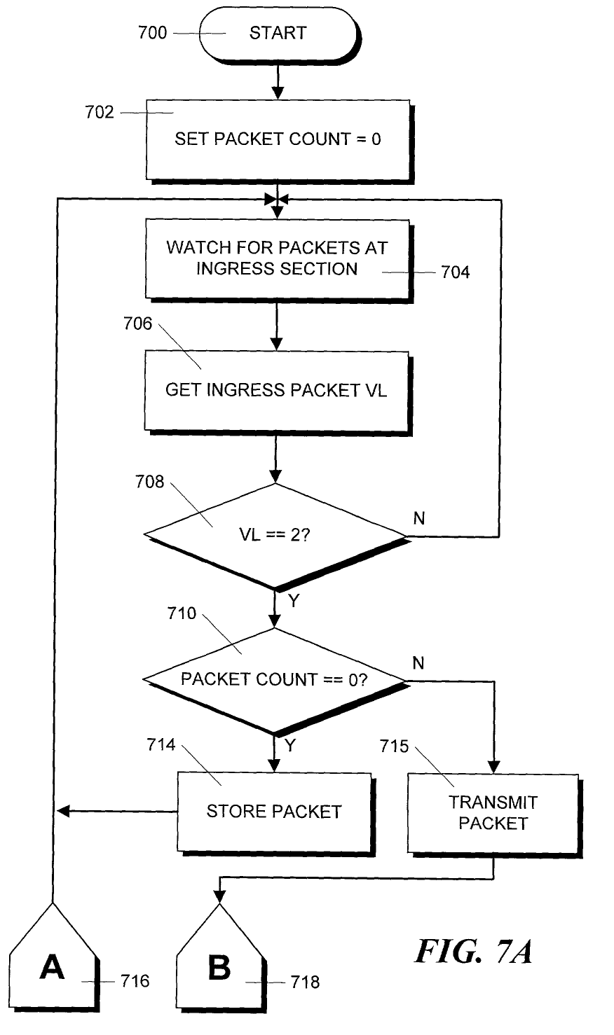

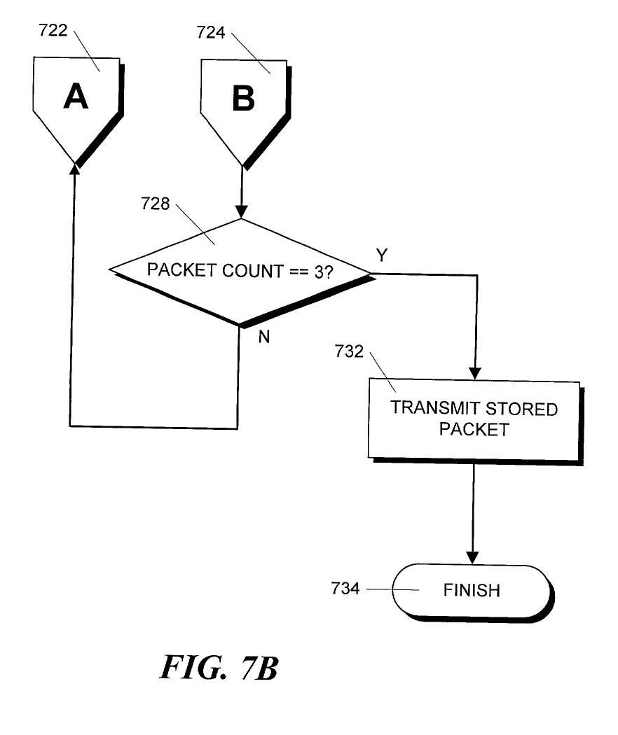

An example of a process that creates out-of-order packets is shown in FIGS. 7A and 7B. This process starts in step 700 and proceeds to step 702 where a packet count variable is set to 0. Next, in step 704, the process watches for the presence of packets at the NLVM ingress section 502 by monitoring the aforementioned packet_ingress_event mechanism. When a packet is detected, the routine proceeds to step 706 in which the ingress packet virtual lane is obtained by using the get_ingress_packet_vl( ) function.

If, in step 708, it is decided that the virtual lane is not equal to 2, then the process proceeds back to step 704 to watch for additional packets. Alternatively, if in step 708, a determination is made that the packet has arrived on virtual lane 2, then, in step 710, the packet count variable is checked to determine whether it is equal to 0. A packet count variable equal to 0 indicates that the received packet is first packet that has been received on virtual lane 2. If so, the process proceeds to step 714 where, instead of transmitting the packet, the packet is stored in the packet array 526. The process then proceeds back to step 704 to watch for additional packets.

Alternatively, if in step 710, it is determined that the packet count variable is not equal to 0 and, thus, the received packet is not the first packet received on virtual lane 2, the packet is transmitted in step 715 and process proceeds, via off-page connectors 718 and 724, to step 728.

In step 728, a determination is made as to whether the packet count is equal to 3. If not, the process proceeds back, via off-page connectors 722 and 716, to step 704 to watch for additional packets. When the third packet on virtual lane 2 is received as indicated by a positive outcome in step 728, the process proceeds to step 732 and transmits the stored packet. Since this packet was the first packet stored, the first and second packets are now out of order. The process then finishes in step 734.

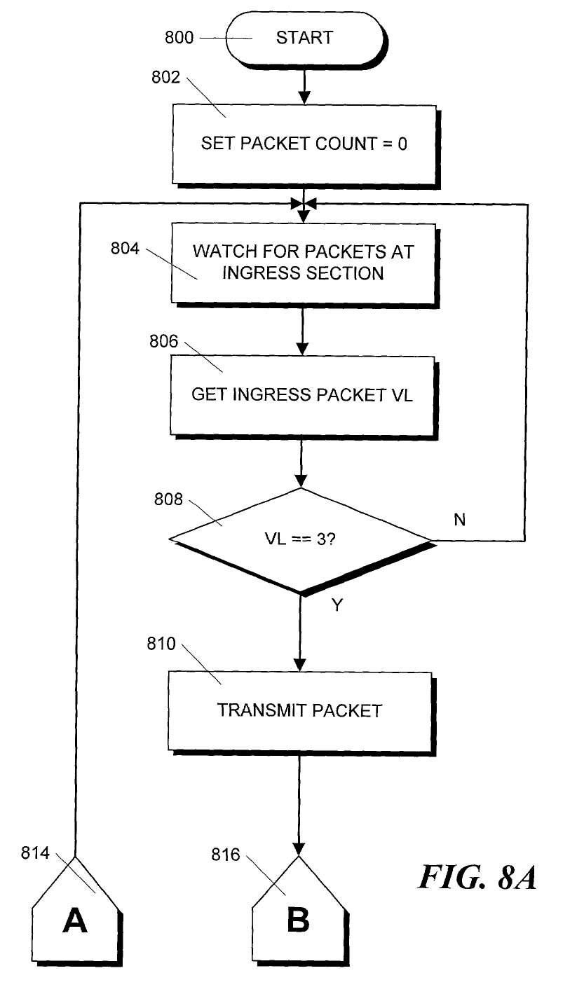

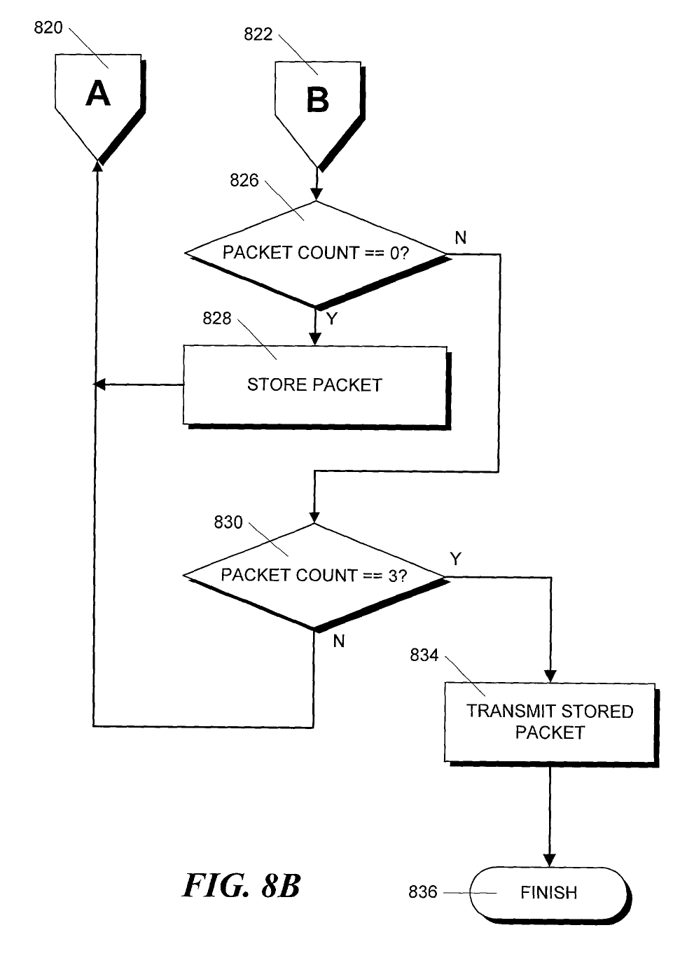

FIGS. 8A and 8B illustrate a process for creating duplicate packets. In particular, the process starts in step 800 and proceeds to step 802 where a packet count variable is set equal to 0. Next, in step 804, the process watches for packets at the NLVM ingress section 502 by monitoring the packet_ingress_event mechanism as previously described.

When a packet has been detected, the process proceeds to step 806 where the ingress packet virtual lane is obtained using the get_ingress_packet_vl( ) function. If the virtual lane is not equal to 3, the process does not operate to duplicate the packets. In particular, the process proceeds back to step 804 to watch for additional packets. Alternatively, if, in step 808, it is determined that the virtual lane is equal to 3 and therefore the process is to duplicate packets, the process proceeds to step 810 in which the packet is transmitted. Then the process proceeds, via off-page connectors 816 and 822, to step 826.

In step 826, the packet count variable is checked to see whether it is 0, indicating that the transmitted packet is the first packet received on virtual lane 3. If so, the packet is stored in step 828. Then, the process proceeds to return, via off-page connectors 820 and 814, to step 804 to watch for additional packets.

Alternatively, if, in step 826, it is determined that the packet count is not equal to 0, indicating that the received packet is not the first packet received, the process proceeds to step 830 in which a determination is made whether the packet count is equal to 3. If not, the process proceeds via off-page connectors 820 and 814 back to step 804 to watch for additional packets.

Alternatively, if in step 830 it is determined that the packet count is equal to 3, then the routine proceeds to step 834 where the stored packet is transmitted creating a duplicate packet transmission and then the routine finishes in step 836.

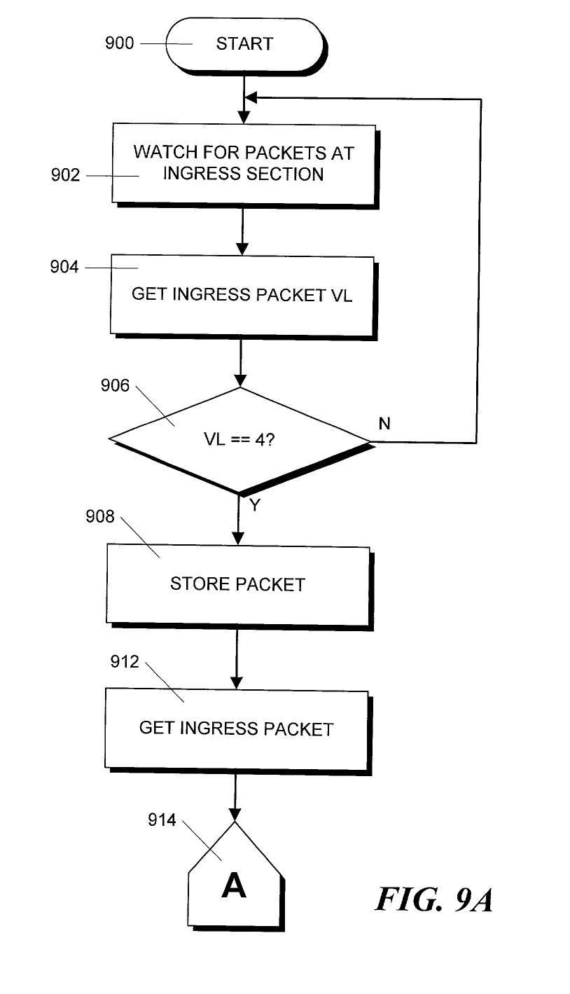

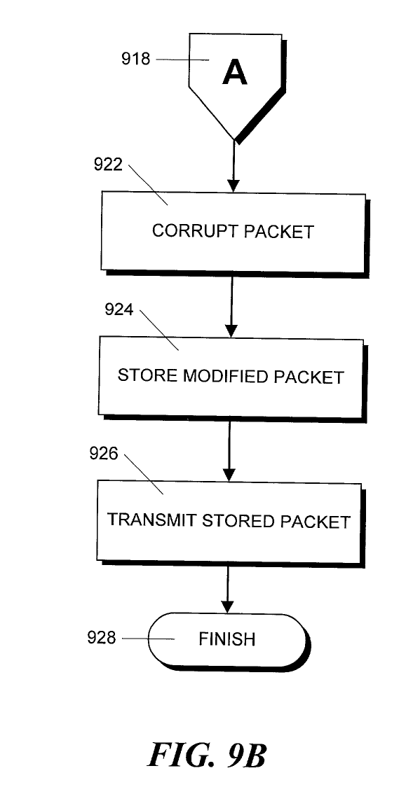

FIGS. 9A and 9B illustrate a process in which packets are corrupted as described above. This process starts in step 900 and proceeds to step 902 where a watch is conducted for packets received at the ingress section by monitoring the packet_ingress_event mechanism. When a packet is determined to have reached the ingress section, the process proceeds to step 904 where the ingress packet virtual lane is obtained using the get_ingress_packet_vl( ) function. Next, in step 906, a determination is made as to whether the virtual lane is equal to 4 and that packets are to be corrupted. If not, the routine proceeds back to step 902 where the process watches for additional packets.

Alternatively, if, in step 906, it is determined that the virtual lane of the packet is 4 and thus the packets are to be corrupted, the process proceeds to step 908 where the packet is stored in the packet array 526. Next, in step 912, a packet is retrieved from the ingress section 502 using the get_ingress_packet( ) function. The routine then proceeds, via off-page connectors 914 and 918, to step 922 where the packet data is corrupted in a known manner. The routine then proceeds to step 924 where the modified packet is saved in the packet array 526 using the modify_stored_packet(packet_handle_{—}4,packet_{—}4) function. Next, in step 926, the modified packet is transmitted using the transmit_stored_packet(packet_handle_4) function. The routine then finishes in step 928.

An exemplary code fragment, which illustrates the foregoing processes and which is coded in VERA™ HVL code as follows:

program main {

NetworkLayerVerificationMechanism nlvm=new( );

// temporary variables (packet_handles_x, packet_x) declaration and initialization.

//code here to setup packets to be sent from one HCA to the other HCA.

// code example for dropping packets

fork {

while(1){

// watch for packets at the ingress

sync(ALL, nlvm.packet_ingress_event);

// for virtual lane 1 packets, we want to create dropped packet conditions

if (nlvm.get_ingress_packet_vl( )==1) {

// don't invoke transmit_ingress_packet( )

printf(“Dropping vl 1 packet\n”);

break;

}

}

} join none

// code example for creating out-of-order packets

fork {

while(1){

// watch for packets at the ingress

sync(ALL, nIvm.packet_ingress_event);

// for virtual lane 2 packets, we want to create out-of-order packet conditions

if (nlvm.get_ingress_packet_vl( )==2) {

// don't invoke transmit_ingress_packet( )

// store the current packet at the ingress if first packet on vl 2

if (vl2_packet_count==0)

packet_handle_{—}2=nlvm.store_ingress_packet( );

else nvlm.transmit_ingress_packet( );

// transmit on 3rd vi 2 packet

if (vl2_packet_count++==3 ) {

nlvm.transmit_stored_packet(packet_handle_{—}2);

break;

}

}

}

} join none

// code example for creating duplicate packets

fork {

while (1) {

// watch for packets at the ingress

sync(ALL, nlvm.packet_ingress_event);

// for virtual lane 3 packets, we want to create duplicate packet conditions

if (nlvm.get_ingress_packet_vl( )==3) {

// transmit the current ingress packet

nlvm.transmit_ingress_packet( );

// store the current packet at the ingress if first packet on vl 3

if (vl3_packet_count==0)

packet_handle_{—}3=nlvm.store_ingress_packet( );

// retransmit on 3rd vl 3 packet

if (vl3_packet_count++==3) {

nlvm.transmit_stored_packet(packet_handle_{—}3);

break;

}

}

}

} join none

// code example for creating corrupt packets

fork {

while (1) {

// watch for packets at the ingress

sync(ALL, nlvm.packet_ingress_event);

// for virtual lane 4 packets, we want to create duplicate packet conditions

if (nlvm.get_ingress_packet_vl( )==4) {

// store the current packet at the ingress

packet_handle_{—}4=nlvm.store_ingress_packet( );

// get packet and corrupt packet

packet_{—}4=nlvm.get_ingress_packet(0);

// . . . code for corrupting the packet

// saved modified packet

nlvm.modify_stored_packet(packet_handle_{—}4, packet_{—}4);

// transmit modified packet

nlvm.transmit_stored_packet(packet_handle_{—}4);

// done

break;

}

}

} join none

fork{

// watch for packets at the ingress

synch(ALL, nlvm.packet_ingress_event);

// catch the packet if the vl is not 1, 2, 3, 4 for the example,

// then transmit it through the egress.

if (nlvm.get_ingress_packet_vl( )!=1 &&

nlvm.get_ingress_packet_vl( )!=2 &&

nlvm.get_ingress_packet_vl( )!=3 &&

nlvm.get_ingress_packet_vl( )!=4)

nlvm.transmit_ingress_packet( );

} join none

// wait for all threads to complete

wait_child( );

}

Although an exemplary embodiment of the invention has been disclosed, it will be apparent to those skilled in the art that various changes and modifications can be made which will achieve some of the advantages of the invention without departing from the spirit and scope of the invention. For example, it will be obvious to those reasonably skilled in the art that, in other implementations, different arrangements can be used for the work queue entries. Other aspects, such as the specific process flow, as well as other modifications to the inventive concept are intended to be covered by the appended claims

What is claimed is:

1. Apparatus for configuration independent simulation of network layer conditions in a simulated network that transmits data packets between a DUT and another component, the apparatus comprising:
a network layer verification mechanism connected between the DUT and the other component, the network layer verification mechanism having a storage and a plurality of methods for selectively forwarding data packets between the DUT and the other component or for selectively storing data packets moving between the DUT and the other component; and
an API interface for invoking the methods to simulate conditions that can occur in the network, including dropped packets, duplicate packets, corrupted packets, out-of-order packets and delayed packets.

2. The apparatus of claim 1 wherein the network layer verification mechanism is implemented as a specialized object written in an HVL.

3. The apparatus of claim 2 wherein the object includes internal storage in the form of an associative array and a plurality of methods that allow packets received by the object to be selectively forwarded through the object, temporarily stored in the object or the packet data to be corrupted.

4. The apparatus of claim 1 wherein the network layer verification mechanism comprises a packet ingress section and a packet egress section.

5. The apparatus of claim 4 wherein the API interface includes a method for transmitting packets between the packet ingress section and the packet egress section.

6. The apparatus of claim 4 wherein the API interface comprises a method for transmitting packets between the packet ingress section and the storage.

7. The apparatus of claim 4 wherein the API interface comprises a method for transmitting a packet stored in the storage to the packet egress section.

8. The apparatus of claim 4 wherein the API interface comprises a method for retrieving a packet stored in the storage.

9. The apparatus of claim 4 wherein the API interface comprises a method for modifying a data packet received at the ingress section.

10. The apparatus of claim 9 wherein the API interface comprises a method for restoring a modified data packet in the storage.

11. A method for configuration independent simulation of network layer conditions in a simulated network that transmits data packets between a DUT and another component, the method comprising:
(a) creating a network layer verification mechanism having a storage and a plurality of methods for selectively forwarding data packets between the DUT and the other component or for selectively storing data packets moving between the DUT and the other component;
(b) connecting the network layer verification mechanism between the DUT and the other component; and
(c) invoking the methods with an API interface to simulate conditions that can occur in the network, including dropped packets, duplicate packets, corrupted packets, out-of-order packets and delayed packets.

12. The method of claim 11 wherein step (a) comprises implementing the network layer verification mechanism as a specialized object written in an HVL.

13. The method of claim 12 wherein step (a) comprises creating the object with internal storage in the form of an associative array and a plurality of methods that allow packets received by the object to be selectively forwarded through the object, temporarily stored in the object or the packet data to be corrupted.

14. The method of claim 11 wherein step (a) comprises receiving packets at a packet ingress section of the network layer verification mechanism and transmitting packets from a packet egress section of the network layer verification mechanism.

15. The method of claim 14 wherein the API interface includes a method for transmitting packets between the packet ingress section and the packet egress section.

16. The method of claim 14 wherein the API interface comprises a method for transmitting packets between the packet ingress section and the storage.

17. The method of claim 14 wherein the API interface comprises a method for transmitting a packet stored in the storage to the packet egress section.

18. The method of claim 14 wherein the API interface comprises a method for retrieving a packet stored in the storage.

19. The method of claim 14 wherein the API interface comprises a method for modifying a data packet received at the ingress section.

20. The method of claim 19 wherein the API interface comprises a method for restoring a modified data packet in the storage.

21. A computer program product for configuration independent simulation of network layer conditions in a simulated network that transmits data packets between a DUT and another component, the computer program product comprising a computer usable medium having computer readable program code thereon, including:
(a) program code that creates a network layer verification mechanism having a storage and a plurality of methods for selectively forwarding data packets between the DUT and the other component or for selectively storing data packets moving between the DUT and the other component;
(b) program code that connects the network layer verification mechanism between the DUT and the other component; and
(c) an API interface that invokes the methods to simulate conditions that can occur in the network, including dropped packets, duplicate packets, corrupted packets, out-of-order packets and delayed packets.

22. The computer program product of claim 21 wherein the program code that creates a network layer verification mechanism comprises program code that implements the network layer verification mechanism by instantiating a as a specialized object written in an HVL.

23. The computer program product of claim 22 wherein the program code that creates a network layer verification mechanism comprises program code that instantiates the object with internal storage in the form of an associative array and a plurality of methods that allow packets received by the object to be selectively forwarded through the object, temporarily stored in the object or the packet data to be corrupted.

24. The computer program product of claim 21 wherein the program code that creates a network layer verification mechanism comprises program code that creates a packet ingress section of the network layer verification mechanism and program code that creates a packet egress section of the network layer verification mechanism.

25. The computer program product of claim 24 wherein the API interface includes a method for transmitting packets between the packet ingress section and the packet egress section.

26. The computer program product of claim 24 wherein the API interface comprises a method for transmitting packets between the packet ingress section and the storage.

27. The computer program product of claim 24 wherein the API interface comprises a method for transmitting a packet stored in the storage to the packet egress section.

28. The computer program product of claim 24 wherein the API interface comprises a method for retrieving a packet stored in the storage.

29. The computer program product of claim 24 wherein the API interface comprises a method for modifying a data packet received at the ingress section.

30. The computer program product of claim 29 wherein the API interface comprises a method for restoring a modified data packet in the storage.

31. A computer data signal embodied in a carrier wave for configuration independent simulation of network layer conditions in a simulated network that transmits data packets between a DUT and another component, the computer data signal comprising:
(a) program code that creates a network layer verification mechanism having a storage and a plurality of methods for selectively forwarding data packets between the DUT and the other component or for selectively storing data packets moving between the DUT and the other component;
(b) program code that connects the network layer verification mechanism between the DUT and the other component; and
(c) an API interface that invokes the methods to simulate conditions that can occur in the network, including dropped packets, duplicate packets, corrupted packets, out-of-order packets and delayed packets.
